(19) United States
(12) Patent Application Publication
(10) Pub. No.: US 2010/0086345 A1
(43) Pub. Date: Apr. 8, 2010

(54) SWIVEL FOR HEAVY LOADS

(75) Inventor: Olav Dale, Akersberga (SE)

Correspondence Address: YOUNG & THOMPSON, 209 Madison Street, Suite 500, Alexandria, VA, 22314, US

(73) Assignee: ROSLAGENS MARINCENTER AB, Akersberga (SE)

(21) Appl. No.: 12/597,011

(22) PCT Filed: Apr. 17, 2008
(86) PCT No.: PCT/SE08/00271

§ 371 Date: Oct. 22, 2009

(30) Foreign Application Priority Data
Apr. 23, 2007 (SE) 0700968-1

(51) Int. Cl. F16G 15/08

(52) U.S. Cl. 403/40

(57) ABSTRACT

A swivel for heavy loads includes two mutually rotatable parts (1, 2) adapted to transfer tensile forces between them during simultaneous relative rotation. The first part (1) has a first sliding surface (11a) and the second part (2) has a second sliding surface (8a). The sliding surfaces are adapted to be able to bear and slide against one another. The first part includes a housing (3) including a cylinder (6) having the first sliding surface (Ha) and the second part includes a piston (8) having the second sliding surface (8a). A hydraulic fluid is introduced between the first and the second sliding surface to normally keep them apart in a non-sliding relationship.

The present invention concerns a swivel for heavy loads as defined in the preamble of claim 1.

When anchoring drilling rigs and off-shore platforms in open sea and deep waters, the anchoring equipment is exposed to extremely heavy loads. Apart from anchors and chains or steel wires, anchoring equipment often includes one or more swivels placed between an anchor and a chain or a wire, or between chain sections or wire sections in order to prevent possible twisting of the chain or wire. The twisting problem is particularly occurring when wires are used and causes a serious problem in that a twisted wire looses much of its strength and often has to be partly or entirely discarded. A corresponding problem exists when anchoring buoys, that tend to rotate and twist an anchoring wire.

A swivel includes two mutually rotatable parts adapted to transfer forces between, e.g., a first and a second length of a wire, and to be connected to a respective one of those lengths. Each swivel part is provided with a sliding surface, adapted to bear against a corresponding sliding surface of the other swivel part.

Prior art swivels having sliding surfaces directly abuting one another (see e.g. SE 517 068, GB 439 986 A and U.S. Pat. No. 4,723,804 A), or, rolling bodies (FR 2429935 A1) located between opposed surfaces, may sufficiently perform their task during normal conditions, but tend to fail when the loads increase, simply because of the correspondingly increasing friction between the mutually rotatable swivel parts, and, in case of rolling bodies, due to pressure concentrations in contact surfaces, respectively.

Consequently, a main object of the present invention is to provide a swivel that maintains its rotatability between its mutually rotatable parts even under extreme load conditions.

In a swivel according to the present invention, the two mutually rotatable parts do not bear against each other, but are hydraulically kept apart by a suitable fluid, such as oil, introduced between the two parts, one of which being formed with a cylinder and the other with a piston.

The present invention will now be described, reference being made to the accompanying drawings, wherein:

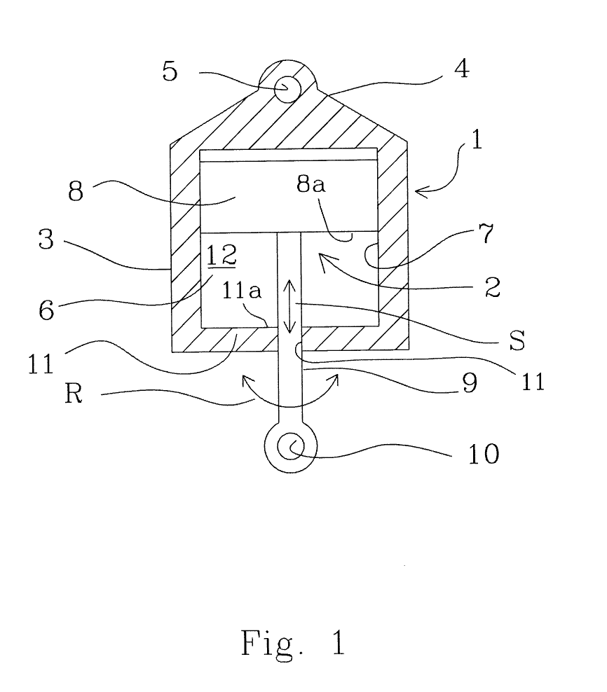

FIG. 1 is a schematic sketch showing the principle of a swivel according to the invention, and

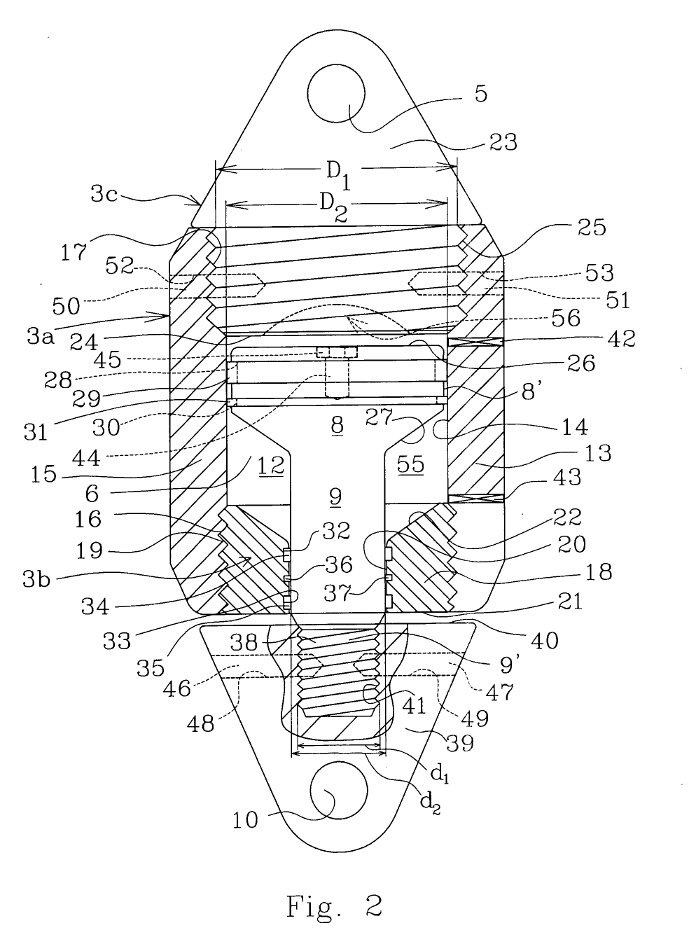

FIG. 2 is a part cross-section through a preferred embodiment thereof.

The swivel of FIG. 1 comprises a first part 1 and a second part 2. The first part 1 comprises a housing 3 with a connection piece 4 having an upper eye 5 for the connection of, e.g., a chain or wire. A circular cylinder 6 having a cylinder wall 7 is shaped in the housing 3. The second part comprises a piston 8 having a lower surface 8a and carrying a piston rod or connection rod 9 having in its free end a lower eye 10 for the connection of, e.g., a chain or wire. The piston is received in a fluid tight manner within the cylinder, where it is longitudinally slidably and rotatably movable as indicated by arrows S and R, respectively. The connection rod extends in a likewise fluid tight manner through a hole 11′ in the bottom wall 11 of the housing 3. A suitable fluid, such as hydraulic oil, is contained within a cylinder space 12 between the bottom wall 11 and the piston 8. Thus, there is a certain distance between the upper surface 11a of the bottom wall 11 and the lower surface 8a of the piston.

Assuming there is a fluid tight relation between the piston and the interior cylinder wall 7, that the fluid is at least substantially incompressible, and that oppositely directed forces are applied to the connection piece 4 and the connection rod 9 striving to move the piston towards the bottom wall 11, the piston will be prevented from any appreciable movement due to the pressure build-up within the cylinder space 12. Thus, the piston will be effectively prevented from contacting the bottom wall 11, and, consequently, friction between the first part 1 and the second part 2 due to relative rotation will be reduced to contact friction between the outer circumference of the piston 8 and the interior cylinder wall 7, as well as between the connection rod 9 and the hole 11′ in the bottom wall 11.

In case of leakage, the surfaces 8a and 11a will approach one another, and the swivel according to FIG. 1 will operate like any prior art swivel, the surfaces 8a and 11a then eventually operating as sliding surfaces.

In FIG. 2, showing a practicable and preferred embodiment of the present invention, the same reference numerals are used as in FIG. 1 for like or corresponding details.

The housing 3 of the preferred embodiment is made up of three sub-parts 3a, 3b and 3c.

Sub-part 3a is a tubular structure 13 having a central cylinder bore 14 and a housing wall 15. A bottom end of the tubular structure is provided with internal threads 16 having substantially the same inner diameter as the cylinder bore. An upper end of the tubular structure is provided with internal threads 17 having a larger inner diameter D₁ than the diameter D₂ of the cylinder bore 14.

The bottom end of the tubular structure 13 is closed by sub-part 3b being a cylinder bottom piece 18 having external threads 19 threaded into the internal threads 16 of the tubular structure. A central hole 20 extends through the bottom piece 18 from a lower surface 21 to an upper concave conical surface 22 being a sliding surface.

The upper end of the tubular structure 13 is closed by sub-part 3c being a cylinder head or top piece 23 constituting a cylinder head and having a bottom surface 24 and external threads 25 threaded into the internal threads 17. An upper end 20 of the top piece 23 is provided with an upper eye 5 for the attachment of a wire or the like.

Like in the principal swivel of FIG. 1, the second part comprises a piston 8 having a piston rod 9, the latter extending through the central hole 20 of the bottom piece 18. The piston has a flat upper surface 26 and a conical bottom surface 27 being a sliding surface merging with the piston rod 9. The conical bottom surface has a cone angle corresponding to that of the upper conical surface 22 of the bottom piece 18.

The exterior piston surface 8′ is provided with at least one groove 28 for a guide ring 29 being in sliding contact with the cylinder surface 14, and at least one groove 30 for a sealing ring 31 being in sealing and sliding contact with the cylinder surface 14.

The central hole 20 is provided with at least one and preferably two grooves 32, 33 for guide rings 34, 35 being in sliding contact with the piston rod 9, and at least one groove 36 for a sealing ring 37 being in sliding and sealing contact with the piston rod 9.

The free end 9′ of the piston rod is provided with external threads 38 having a smaller external diameter d₁ than the diameter d₂ of the piston rod.

A connection piece 39 having an upper surface 40 is provided with internal threads 41 matching the threads 38 of the piston rod. A bottom end of the connection piece is provided with a lower eye 10 for the attachment of a wire or the like.

At the upper end of the cylinder bore 14, substantially flush with the bottom surface 24 of the cylinder top piece 23, the housing wall 15 is provided with at least one nipple 42 and preferably two or more such nipples distributed around the periphery of the housing wall. At least one further nipple 43 and preferably two or more such nipples are provided in the housing wall 15 at a section thereof where the upper, conical surface of the bottom piece 18 meets the wall 15. Nipples 42 and 43 are provided for filling hydraulic fluid, particularly oil, into the cylinder space 12 and for bleeding air therefrom.

When assembling the swivel according to FIG. 2, the bottom piece 18 is first threaded from below into the internal threads 16 of the tubular structure 13. Then, the piston is introduced from above into the cylinder 6 with its piston rod 9 facing downwards towards the hole 20 in the bottom piece 18.

Due to the difference between the reduced, outer diameter d₁ of the threads 38 at the lower end of the piston rod 9 and the diameter d₂ thereof, the threads may pass the guide and sealing rings 34, 35, 36 without risk of damaging the latter.

Likewise, due to the difference between the increased inner diameter D₁ of the internal threads 17 and the diameter D₂ of the cylinder bore 14, there is sufficient allowance for the guide and sealing rings 29, 31 in the circumference of the piston to pass the threads 17 without any risk of damaging the latter.

For facilitated mounting of the piston 8, a central, threaded bottom hole 44 may be provided in its upper surface 26 for receiving a correspondingly threaded end of a suitable mounting rod (not shown) used to control the piston during its introduction into the cylinder. Suitably, an upper portion of the bottom hole 44 is widened to form an internal hexagon 45 or other shape suited for positive rotational engagement with the piston.

After introduction of the piston into the cylinder, the connection piece 39 is threaded onto the threads 38 of the piston rod. When tightening the thread engagement between the piston and the connection piece, a suitable tool (not shown) having an exterior hexagon (or other shape) is inserted into the hexagon 45 to control rotation of the piston relative to the connection piece.

In order to positively lock the connection piece 39 in relation to the piston rod, locking bolts 46, 47 may be inserted into corresponding holes 48, 49, in the connection piece and the piston rod.

Finally, the cylinder top piece 23 is threaded into the internal threads 17 of the tubular structure 13 and tightened. In order to positively lock the top piece in relation to the tubular structure, locking bolts 50, 51 may be inserted into corresponding holes 52, 53 in the tubular structure and the top piece.

Due to the substantial pressures prevailing at large depths, it is important that all thread joints, including threaded plugs (not shown) for the nipples, are properly sealed by a suitable sealing compound.

With the piston 8 in its bottom position, where the conical surface 22 of the cylinder bottom piece 18 and the conical surface 27 of the piston approximately abut one another like sliding surfaces of prior art swivels, hydraulic fluid 55 is pressed through the nipple 43 into the cylinder space 12 of the cylinder 6. The nipple 42 being opened for air bleed, the piston is raised towards it top position shown in FIG. 2.

Due to possible thermal expansion of the fluid 55 contained within the cylinder space 12, tending to force the piston 8 further upwards, it is preferred to maintain a distance between the top surface 26 of the piston and the bottom surface 24 of the top piece 23 in the nominal top position of the piston shown in FIG. 2. The cylinder volume defined by said distance contains air being compressed upon upwards movement of the piston. Apart from this air volume, it is preferred to let a small volume of hydraulic fluid into the space above the piston for sealing and lubricating purposes.

Of course, at least a distance corresponding to the distance just mentioned must exist between the bottom surface 21 of the cylinder bottom piece 18 and the upper surface 40 of the connection piece 39.

In order to facilitate upward movement of the piston in case a larger oil volume is present at the top of the piston, a cavity 56 is provided centrally in the bottom surface of the top piece 23 in order to enlarge the available air volume, leaving a peripheral, annular surface 24 at the bottom of the top piece. Upon upward movement of the piston, air contained within the cavity 56 will easily be compressed and permit upward movement of the piston due to thermal expansion of the hydraulic fluid.

In case of leakage, the two sliding surfaces 22 and 27 will approach one another, and the swivel will operate like any prior art swivel.

It is apparent that modifications may be made to the preferred embodiment described with reference to FIG. 2. For instance, there may be more than one upper eye 5 and more than one lower eye 10 for connecting the swivel to more than one object above and more than one object below the swivel, respectively.

The swivel principle described herein may also be adapted to and built into other structures, such as turret mooring systems and floating off-shore wind generators.

1. A swivel for heavy loads including two mutually rotatable parts (1, 2; 3a,b,c, 8, 9) adapted to transfer tensile forces between them during simultaneous relative rotation, said first part (1; 3a,b,c) having a first sliding surface (11a; 22) and said second part (2; 8, 9) having a second sliding surface (8a, 27), said first and second sliding surfaces being adapted to bear and slide against one another, said first part comprising a housing (3; 3a,b,c) provided with a first connection means (5) for a first traction means and including a cylinder (6) having in one axial end thereof said first sliding surface (11a; 22), and said second part comprising a piston (8) located within said cylinder and having a piston rod (9) extending through said housing (3; 3b) and being provided with a second connection means (10) for a second traction means, said housing having in one axial end thereof said second sliding surface (8a; 27), a hydraulic fluid (55) being located between said swivel parts, characterized in that the cylinder (6) and the piston (8) are axially displaceable relative one another between a first position, in which said first and second sliding surfaces (11a, 8a; 22, 27) substantially abut and slide against one another, and a second position, in which said sliding surfaces are spaced from one another, said hydraulic fluid (55) being fluid tightly enclosed within a space (12) of said cylinder between said sliding surfaces to keep said cylinder (8) and said piston (6) in said second position with said sliding surface spaced from one another in a non-sliding relationship.

2. The swivel according to claim 1, characterized in that between said piston (8) and an internal cylinder wall (14) is at least one sealing (31) and that between said piston rod (9) and said housing (3b) is at least one sealing (37).

3. A swivel according to claim 1, in which means (43) are provided for introducing hydraulic fluid in said cylinder (6) between said two swivel parts, characterized in that said means (43) for introducing hydraulic fluid (55) between said swivel parts open in a cylinder space (12) of said cylinder at a position thereof located between said sliding surfaces in said first position of said cylinder (6) and said piston (8).

4. The swivel according to claim 1, characterized in that said housing (3a,b,c) comprises a tubular structure (13) having a central cylinder bore (14) accommodating said piston (8), a cylinder top piece (23) and a cylinder bottom piece (18).

5. The swivel according to claim 4, characterized in that said cylinder top piece (23) has a cavity (56) in a bottom surface (24) thereof.

6. The swivel according to claim 4, characterized in that said cylinder top piece (23) is provided with attachment means (5) for the attachment of the swivel to an object above the swivel.

7. The swivel according to claim 4, characterized in that said cylinder bottom piece (18) is provided with said first sliding surface (22).

8. The swivel according to claim 4, characterized in that said cylinder bottom piece (18) has a hole (20) through which extends a piston rod (9) of said piston (8).

9. The swivel according to claim 1, characterized in that said first and second sliding surfaces (8a, 11a) are perpendicular to a common axis of said piston (8) and said cylinder (6).

10. The swivel according to claim 1, characterized in that said first and second sliding surfaces (22, 27) are conical and have corresponding cone angles.

11. A swivel according to claim 2, in which means (43) are provided for introducing hydraulic fluid in said cylinder (6) between said two swivel parts, characterized in that said means (43) for introducing hydraulic fluid (55) between said swivel parts open in a cylinder space (12) of said cylinder at a position thereof located between said sliding surfaces in said first position of said cylinder (6) and said piston (8).

12. The swivel according to claim 5, characterized in that said cylinder top piece (23) is provided with attachment means (5) for the attachment of the swivel to an object above the swivel.

13. The swivel according to claim 5, characterized in that said cylinder bottom piece (18) is provided with said first sliding surface (22).

14. The swivel according to claim 6, characterized in that said cylinder bottom piece (18) is provided with said first sliding surface (22).

15. The swivel according to claim 5, characterized in that said cylinder bottom piece (18) has a hole (20) through which extends a piston rod (9) of said piston (8).

16. The swivel according to claim 6, characterized in that said cylinder bottom piece (18) has a hole (20) through which extends a piston rod (9) of said piston (8).
